(19) United States
(12) Patent Application Publication
(10) Pub. No.: US 2021/0242923 A1
(43) Pub. Date: Aug. 5, 2021

(54) USER TERMINAL AND RADIO BASE STATION

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Xiaolin Hou, Beijing (CN)

(73) Assignee: NTT DOCOMO, INC., Tokyo (JP)

(21) Appl. No.: 17/053,982

(22) PCT Filed: May 10, 2018
(86) PCT No.: PCT/JP2018/018224

§ 371 Date: Nov. 9, 2020

(51) Int. Cl. H04B 7/06; H04W 24/08; H04W 76/19; H04W 72/04

(52) U.S. Cl. CPC H04B 7/0695; H04W 24/08; H04W 72/046; H04W 72/042; H04W 76/19

(57) ABSTRACT

A user terminal has a receiving section that receives a downlink signal, and a control section that compares at least one threshold set, among a number of threshold sets, with a value that is based on receipt of the downlink signal, and the threshold sets are associated with a number of communication requirements, respectively, and the threshold sets each include a number of thresholds for at least one of radio link monitoring and beam failure detection.

### TECHNICAL FIELD

The present disclosure relates to a user terminal and a base station in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower latency and so on (see non-patent literature 1). In addition, the specifications of LTE-A (LTE advanced and LTE Rel. 10, 11, 12 and 13) have also been drafted for the purpose of achieving increased capacity and enhancement beyond. LTE (LTE Rel. 8 and 9).

Successor systems of LTE are also under study (for example, referred to as “FRA (Future Radio Access),” “5G (5th Generation mobile communication system),” “5G+ (plus),” “NR (New Radio),” “NX (New radio access),” “FX (Future generation radio access),” “LTE Rel. 14 or 15 and later versions,” etc.).

In existing LTE systems (LTE Rel. 8 to 13), the quality of a radio link is subject to monitoring (RLM (Radio Link Monitoring)). When a radio link failure (RLF) is detected based on RLM, a user terminal (UE (User Equipment)) is required to re-establish the RRC (Radio Resource Control) connection.

### CITATION LIST

### Non-Patent Literature

Non-Patent Literature 1: 3GPP TS36.300 V8.12.0 “Evolved Universal Terrestrial Radio Access (E-UTRA) and Evolved Universal Terrestrial Radio Access Network (E-UTRAN); Overall Description; Stage 2 (Release 8),” April, 2010

### SUMMARY OF INVENTION

### Technical Problem

Envisaging future radio communication systems (for example, NR), the method of radio link monitoring (RLM) for detecting radio link failures (RLFs) is being discussed.

Furthermore, NR is under study to carry out communication using beamforming (BF). When beamforming is used (for example, when narrower beams are anticipated to be used in higher frequency bands), the quality of beams (also referred to as, for example, “BPLs (Beam Pair Links),” “beam links,” etc.) might deteriorate due to blockage caused by obstacles and/or the like, and, as a result of this, RLFs (Radio Link Failures) might occur frequently. When an RLF occurs, it is necessary to re-connect with cells, so that, frequent occurrence of RLFs may lead to a decline in system throughput. In order to prevent RLFs from occurring, detecting beam failures, in which the quality of specific beams deteriorates, and switching to other beams of better quality (BFR (Beam Failure Recovery)) have been under research.

Failure to detect the quality of at least one of a radio link and a beam link properly might result in a decline in system performance.

It is therefore an object of the present disclosure to provide a user terminal and a radio base station that detect the quality of at least one of a radio link and a beam link properly.

### Solution to Problem

In accordance with one aspect of the present disclosure, a user terminal has a receiving section that receives a downlink signal, and a control section that compares at least one threshold set, among a number of threshold sets, with a value that is based on the receipt of the downlink signal, and, in this user terminal, the threshold sets are associated with a number of communication requirements, respectively, and the threshold sets each include a number of thresholds for at least one of radio link monitoring and beam failure detection.

### Advantageous Effects of Invention

According to one aspect of the present disclosure, the quality of at least one of a radio link and a beam link can be detected properly.

### BRIEF DESCRIPTION OF DRAWINGS

FIG. 1 is a schematic diagram in which RLF is detected based on IS/OOS;

FIG. 2 is a diagram to show an example of BFR procedures;

FIGS. 3A and 3B are diagrams to show examples of MCS tables;

FIG. 4 is a diagram to show an exemplary schematic structure of a radio communication system according to the present embodiment;

FIG. 5 is a diagram to show an exemplary overall structure of a radio base station according to the present embodiment;

FIG. 6 is a diagram to show an exemplary functional structure of a radio base station according to the present embodiment;

FIG. 7 is a diagram to show an exemplary overall structure of a user terminal according to the present embodiment;

FIG. 8 is a diagram to show an exemplary functional structure of a user terminal according to the present embodiment; and

FIG. 9 is a diagram to show an exemplary hardware structure of a radio base station and a user terminal according to the present embodiment.

### DESCRIPTION OF EMBODIMENTS

Future radio communication systems (for example, LTE Rel. 14 or later versions, NR or 5G, etc.) are under study to carry out communication using beamforming (BF).

For example, beams that are used by a user terminal and/or a radio base station (for example, a gNB (gNodeB)) include beams that are used to transmit signals (also referred to as “transmitting beams,” “Tx beams,” etc.), beams that are used to receive signals (also referred to as “receiving beams,” “Rx beams,” etc.) and so forth. A pair of a transmitting beam for the transmitting end and a receiving beam for the receiving end may be referred to as a “beam pair link (BPL),” a “beam link,” etc.

In an environment to use BF, a radio link is more susceptible to the impact of obstacle-induced blockage, and therefore the quality of the radio link is more likely to deteriorate. There is a danger that, if the quality of a radio link deteriorates, radio link failures (RLFs) might occur frequently. Since it is necessary to re-connect with cells when an RLF occurs, frequent occurrence of RLFs might lead to a decline in system throughput.

For this reason, the method of radio link monitoring (RLM) for future radio communication systems is being discussed. For example, envisaging future radio communication systems, research is underway to support one or more downlink signals (also referred to as (“DL-RSs (Reference Signals),” “RLM-RS,” etc.) for RLM.

Resources for DL-RSs (“DL-RS resources,” “RLM-RS resources,” etc.) may be associated with resources and/or ports for synchronization signal blocks (SSBs) or channel state measurement RSs (CSI-RSs (Channel State Information RSs)). Note that SSBs may be referred to as “SS/PBCH (Physical Broadcast CHannel) blocks” and the like.

DL-RSs may be at least one of a primary synchronization signal (PSS (Primary SS)), a secondary synchronization signal (SSS (Secondary SS)), a mobility reference signal (MRS (Mobility RS)), a CSI-RS, a tracking reference signal (TRS (Tracking RS)), a demodulation reference signal (DMRS), a beam-specific signal and so forth, or may be a signal formed by enhancing and/or modifying these (for example, a signal formed by changing the density and/or the period).

A user terminal may be configured, by higher layer signaling, to perform measurements using DL-RS resources. In this case, the assumption is that the user terminal, where such measurements are configured, determines whether a radio link is in a synchronous state (IS (In-Sync)) or in an asynchronous state (OOS (Out-Of-Sync)), based on measurement results in DL-RS resources.

Default DL-RS resources to allow the user terminal to conduct RLM in the event no DL-RS resource is configured from a radio base station may be set forth in the specification.

If the quality of a radio link that is estimated (or “measured”) based at least on one DL-RS resource that is configured exceeds a first threshold (for example, Qᵢₙ) (higher than a first threshold), the user terminal may judge that the radio link is in IS.

If the quality of a radio link that is estimated based at least on one DL-RS resource configured falls below a second threshold (for example, Qₒᵤₜ) (lower than a second threshold), the user terminal may judge that the radio link is in OOS. Note that the radio link quality here may correspond to, for example, the block error rate (BLER) of a hypothetical PDCCH.

For example, Qᵢₙ corresponds to a hypothetical PDCCH BLER of 2%, and Qₒᵤₜ corresponds to a hypothetical PDCCH BLER of 10%.

IS and/or OOS, which are judged at regular intervals (periodically), may be referred to as “periodic IS (P-IS)/periodic OOS (P-OOS).” For example, IS/OOS to be judged using RLM-RSs may be P-IS/OOS.

In existing LTE systems (LTE Rel. 8 to 13), IS and/or OOS (IS/OOS) are indicated from the physical layer to higher layers (for example, the MAC layer, the RRC layer, etc.) in a user terminal, and RLF is detected based on the IS/OOS indication.

To be more specific, when a user terminal receives an OOS indication for a given (predetermined) cell (for example, the primary cell) a given number of times (for example, N310 times), the user terminal will activate (start) a timer T310. When the user terminal receives an IS indication for the given cell N311 times while the timer T310 is running, the user terminal will stop the timer T310. When the timer T310 expires, the user terminal judges that RLF has been detected with respect to this given cell.

Note that the names “N310,” “N311,” “T310” and others are by no means limiting. T310 may be referred to as the “timer for RLF detection” or the like. N310 may be referred to as “the number of times OOS is indicated before timer T310 is activated” or the like. N311 may be referred to as “the number of times IS is indicated before the timer T310 is stopped” or the like.

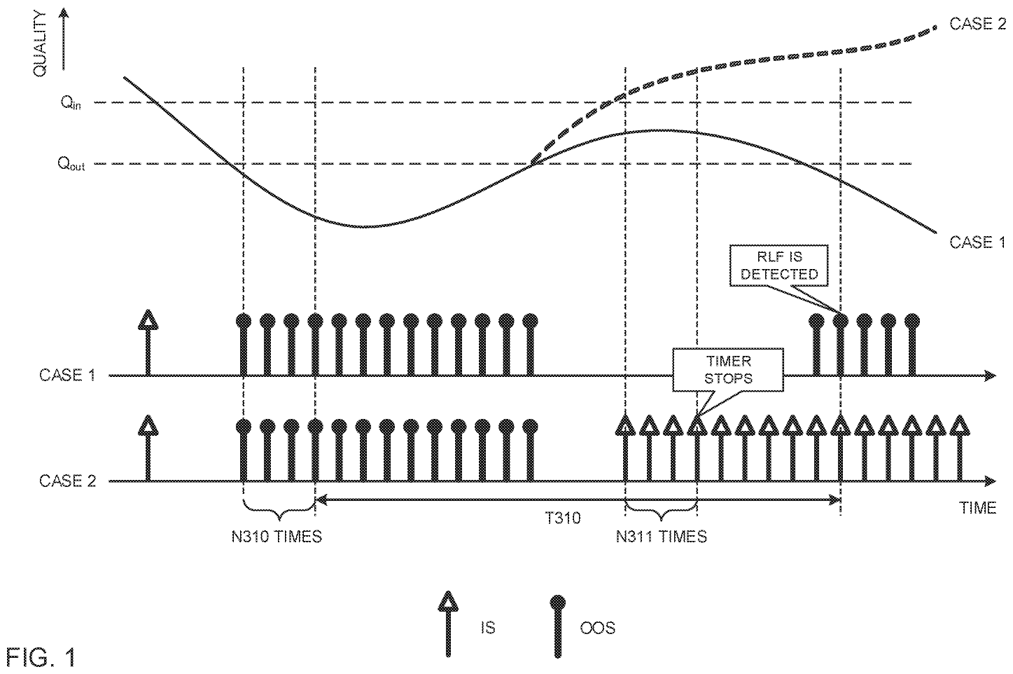

FIG. 1 is a schematic diagram in which RLF is detected based on IS/OOS. This drawing assumes that N310=N311=4. T310 shows the period from the activation of timer T310, to its expiration, but does not show a timer counter.

The upper part of FIG. 1 shows two cases (case 1 and case 2) in which the estimated quality of a radio link changes. The lower part of FIG. 1 shows IS/OOS indications corresponding to the above two cases.

In case 1, first, OOS occurs N310 times, and the timer T310 starts. After that, T310 expires while the radio link quality does not exceed the threshold Qᵢₙ, and therefore RLF is detected.

In case 2, although the timer T310 starts as in case 1, following this, the radio link quality exceeds the threshold Qᵢₙ and IS occurs N311 times, and so T310 stops.

Also, as for configuring UE with a pair (set) of values corresponding to an IS BLER and an OOS BLER, NR is under study to configure UE with one pair, out of two pairs, for one cell group. Assuming this case, studies are in progress, in which one IS or OOS is reported from UE for one cell group, and in which the UE is configured with one IS BLER and one OOS BLER at a given point in time.

Furthermore, envisaging future radio communication systems (for example, LTE Rel. 14 or later version, NR, 5G, etc.), research is being conducted on executing procedures for switching to other beams (which may be referred to as “beam failure recovery (BFR),” “L1/L2 beam recovery,” etc.) when the quality of a particular beam (beam link quality) deteriorates, so as to prevent the occurrence of an RLF.

As mentioned earlier, RLF is detected by controlling RS measurements in the physical layer and the activation and expiration of timers in higher layers, and, in addition, recovery from RLF should follow the same procedures as random access. Meanwhile, there is an expectation that the procedures for switching to other beams (BFR and L1/L2 beam recovery) will be made simpler than the recovery from at least in part of the layers. Note that the BFR procedures may be referred to as “BER request procedures,” “link reconfiguration procedures,” and so on.

The BFR procedures may be triggered by a beam failure. A beam failure, as used in this context, may indicate, for example, that one, several or all of the control channels have not been detected in UE and/or a base station for a given period, or that the measurement result of the received quality of a reference signal associated with a control channel has failed to fulfill given quality.

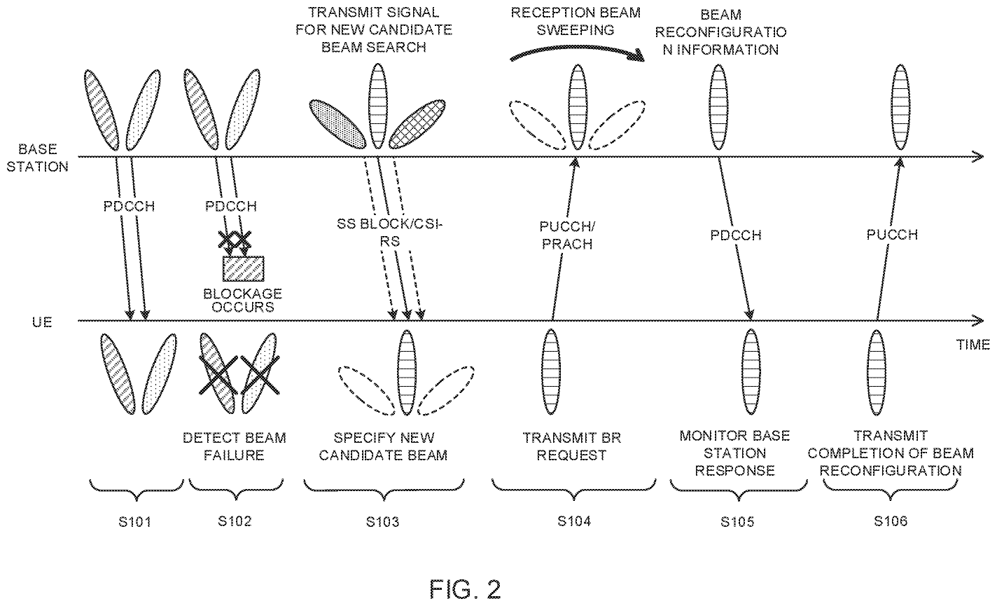

FIG. 2 is a diagram to show an example of BFR procedures. The number of the beams and the like are simply examples and not limiting. In the initial state shown in FIG. 2 (step S101), a user terminal receives a downlink control channel (PDCCH (Physical Downlink Control CHannel)), which is transmitted from a radio base station using two beams.

In step S102, the radio wave from the radio base station is blocked, and so the user terminal is unable to detect the PDCCH. Such blocking might occur due to, for example, the impact of obstacles between the user terminal and the radio base station, fading, interference and so forth.

The user terminal detects a beam failure when a given condition is fulfilled. The given condition may be, for example, the case where all the measurement results of one or more pre-configured DL-RS resources are lower than a given threshold Q_{out, LR}. The radio base station may judge that the user terminal has detected a beam failure when no report arrives from the user terminal, or the radio base station may judge that a beam failure has been detected when a given signal (beam recovery request in step S104) is received from the user terminal.

In step S103, for BFR, the user terminal starts a search for new candidate beams to use for communication anew. To be more specific, upon detecting a beam failure, the user terminal performs measurements based on pre-configured DL-RS resources, and identifies one or more new candidate beams that are desirable (that have good quality and are preferred, for example). In this example, one beam is identified as a new candidate beam.

In step S104, the user terminal, having specified a new candidate beam, transmits a BFR request (BFR request signal or “BFRQ”). The BFR request may be transmitted using, for example, a random access channel (PRACH (Physical Random Access CHannel)).

PRACH resources may be configured by a higher layer signaling (for example, RRC signaling). PRACH resources may include time domain resources, frequency domain resources, the PRACH sequence, and so forth.

The BFR request may include information about the new candidate beam identified in step S103. The PRACH resource for the BFR request may be associated with the new candidate beam. For example, one or more PRACH resources and/or sequences may be configured for each new candidate beam, so that the user terminal can determine the resource and/or the sequence for a PRACH to transmit as a BFR request depending on the new candidate beam specified. Information about the beam may be reported by using, for example, a beam index (BI), a given reference signal's port and/or resource index (for example, CSI-RS resource indicator (CRI)), and so forth.

In step S105, the radio base station, having detected the BFR request, transmits a response signal in response to the BFR request (BFR request response (BFRQ response)) from the user terminal. This BFR request response may include reconfiguration information (for example, DL-RS resource configuration information) associated with one or more beams. The BFR request response may be transmitted, for example, in a user-specific search space as a PDCCH, or may be transmitted in a user terminal-common search space as a PDCCH. Upon detecting the response signal, the user terminal may recognize that the BFR has been successful. The user terminal may determine which transmitting beam and/or receiving beam is to use based on the beam reconfiguration information.

In step S106, the user terminal may transmit, to the radio base station, a message to indicate that beam reconfiguration has been completed. This message may be transmitted by using a PUCCH, for example.

A BFR success may refer to, for example, the case in which the procedures reach step S106. Meanwhile, a BFR failure refers to the case in which the procedures do not reach step S106 (for example, a case where no candidate beam could be specified in step S103).

In a future radio communication system (for example, 5G or NR), for example, a number of types of communications (also referred to as “use cases,” “services,” “communication types,” etc.) with different requirements (communication requirements) such as high speed and large capacity (for example, eMBB (enhanced Mobile Broad Band)), a very large number of terminals (for example, mMTC (massive Machine Type Communication), IoT (Internet of Things), etc.), ultra-high reliability and low latency (for example, URLLC (Ultra Reliable and Low Latency Communications)) are anticipated. Note that the requirements may include, for example, at least one of latency, reliability, capacity, speed, and performance.

For example, the difference between the requirements for URLLC and the requirements for eMBB may be that the latency of URLLC is less than the latency of eMBB, or that the requirements for URLLC include the requirements for reliability. For example, the U-plane latency requirements for eMBB may include that the downlink U-plane latency should be 4 ms and the uplink U-plane latency should be 4 ms. On the other hand, the U-plane latency requirement for URLLC may include that the downlink U-plane latency should be 0.5 ms and the uplink U-plane latency should be 0.5 ms. Furthermore; the reliability requirements for URLLC may include that the 32-byte error rate should be 10⁻⁵ at 1-ms U-plane latency.

In addition, studies are underway to allow UE to monitor only the radio link quality (RLM) of the primary cell (PCell). In NR, what RLM requirements should be applied to services with different requirements such as eMBB and URLLC has not yet been decided yet.

For example, for RLM on the Men, existing Qᵢₙ and Qₒᵤₜ (for example, corresponding to BLER 2% and BLER 10%, respectively) may not be suitable for services (for example, URLLC) that meet future high-reliability requirements.

Also, for NR, monitoring the beam link quality of each serving cell by UE is under study. The UE may compare the estimation results of downlink radio link quality with each of Q_{out, LR} and Q_{in, LR}, to detect whether or not a beam failure has occurred.

Q_{out, LR} and Q_{in, LR} may correspond to the default values of the higher layer parameters rlmInSyncOutOfSyncThreshold (or RLM-IS-OOS-thresholdConfig) and candidateBeamThreshold (or Beam-failure-candidate-beam-threshold), respectively. rlmInSyncOutOfSyncThreshold may be information (index) to indicate a BLER threshold pair for IS and OOS. candidateBeamThreshold may be information to indicate a threshold (range) for the received power (for example, L1 (Layer 1)-RSRP (Reference Signal Received Power)) for determining whether or not a candidate beam is to be used for BFR.

When carrying out beam failure detection per serving cell, cases might occur where existing Q_{in, LR} and Q_{out, LR} are not appropriate for each of a number of services in one serving cell.

As described above, in future radio communication systems, cases might occur where there are services with different communication requirements, and where at least one of radio link quality and beam link quality cannot be determined properly.

So, the present inventors have come up with the idea of using a number of threshold sets associated with a number of communication requirements.

Now, embodiments according to the present disclosure will be described below in detail with reference to the accompanying drawings. The herein-contained embodiments may be used individually, or may be used in combination.

The requirements for communication according to the present disclosure may include, for example, those for eMBB, URLLC, or a combination of these. The requirements for communication may be associated with configuration information for fulfilling the communication requirements (for example, an MCS (Modulation and Code Scheme) table, a CQI (Channel Quality Indication) table, numerologies, frequency bands, higher layer parameters, given fields of DCI, DCI formats, etc.).

A threshold set, according to the present disclosure, may include thresholds corresponding to at least one of a set of Qᵢₙ and Qₒᵤₜ, and a set of Q_{out, LR} and Q_{in, LR}.

UE may compare values that are based on the receipt (receiving result, estimation result, measurement result, etc.) of downlink signals (for example, RLM-RS, etc.) with a particular set of thresholds. Furthermore, the UE may report the results of comparison. The values based on the receipt of downlink signals may be at least one of the error rate (for example, hypothetical PDCCH BLER), the received power (for example, RSRP, L1-RSRP, RSSI (Received Signal Strength Indicator), etc.), and the received quality (for example, RSRQ (Reference Signal Received Quality), SINR (Signal to Noise and Interference Ratio), etc.).

Note that the primary cell (PCell) may be a special cell. In DC (Dual Connectivity), the PCell in the MCG (Master Cell Group) and the PSCell (Primary Secondary Cell) in an SCG (Secondary Cell Group) may be special cells. Secondary cells (SCell) may be cells other than special cells.

### First Example

A first example of the present invention will describe the requirements for RLM.

To provide threshold sets corresponding to Qᵢₙ and Qₒᵤₜ, a number of threshold sets may be defined in advance by the specification, or may be configured from the NW (network, which is, for example, a radio base station, a gNB, an eNB, a TRP (Transmission/Reception Point), etc.). These threshold sets may be configured by at least one of higher layer signaling and physical layer signaling. The threshold sets may include thresholds for the hypothetical PDCCH BLER, corresponding to Qᵢₙ and Qₒᵤₜ.

One of following options 1-1 to 1-4 may be used for a number of services (for example, eMBB, URLLC, etc.).

<Option 1-1>

One threshold set may be selected from a number of threshold sets based on UE capabilities.

Given two threshold sets, UE may select different threshold sets depending on whether or not the UE supports URLLC alone. To say that UE supports URLLC alone may mean that the UE supports only the functions for URLLC (URLLC configuration information). The configuration information may be at least one of an MCS (Modulation and Code Scheme) table and a CQI (Channel Quality Indication) table. For example, when configuration information for eMBB and configuration information for URLLC are specified in the specification, to say that UE supports URLLC alone may mean that the UE supports the URLLC configuration information alone.

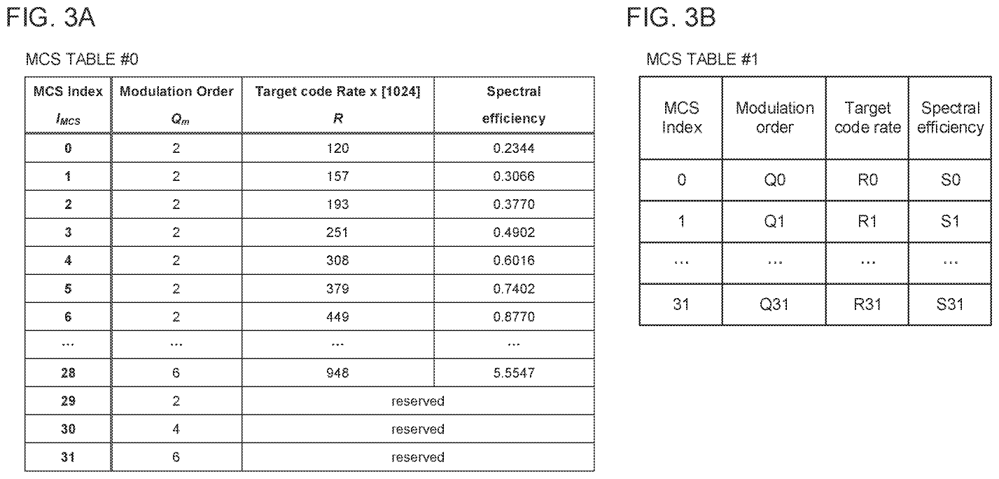

The MCS table contains a number of entries. Each entry contains a number of fields related to MCS. For example, referring to MCS table #0, as shown in FIG. 3A, each entry may include at least one of an MCS index (I_{MCS}), which specifies the entry, a modulation order Qₘ), a target coding rate (R), and spectral efficiency.

The UE may receive PDSCH-scheduling DCI (DL assignment, which may be at least one of DCI formats 1_0 and 1_1) and determine the modulation order Qₘ and the coding rate R for the PDSCH based on the MCS table and the MCS index I_{MCS} included in that DCI.

Also, the UE may receive PUSCH-scheduling DCI (DL grant, which may be at least one of DCI formats 0_0 and 0_1) and determine the modulation order Q and the coding rate R for the PUSCH based on the MCS table and the MCS index I_{MCS} included in that DCI.

For example, MCS table #1 (which is shown in FIG. 3B, and which is the MCS table for URLLC), apart from MCS table #0 (which is shown in FIG. 3A, and which is the MCS table for eMBB), may be defined in the specification. MCS table #0 may be used for eMBB, and MCS table #1 may be used for URLLC. MCS table #0 and MCS table #1 may be defined so that at least one of the modulation order, the target coding rate, and the spectral efficiency shown under the same MCS index value is different, or may be defined so that, for at least one MCS index, the modulation order, the target coding rate and the spectral efficiency are all the same between both tables. In this case, this MCS index enables proper receipt/decoding (or coding/transmission) regardless of which table is used, and therefore is suitable for transmitting and receiving data (for example, broadcast/multicast data) that applies in common to UEs using both tables.

Also, given two threshold sets, the UE may select different threshold sets depending on whether or not the UE supports eMBB alone. To say that UE supports eMBB alone may mean that the UE supports only the functions for eMBB (eMBB configuration information). For example, when configuration information for eMBB and configuration information for URLLC are specified in the specification, to say that UE supports eMBB alone may mean that the UE supports the eMBB configuration information alone.

Furthermore, the UE may select a threshold set associated with a service or a combination of services which the UE supports, from a number of threshold sets. For example, three threshold sets may be associated with the case where the UE supports eMBB alone, the case where the UE supports URLLC alone, and the case where the UE supports both eMBB and URLLC, respectively. To say that UE supports both eMBB and URLLC may mean that the UE supports both the functions for eMBB and the functions for URLLC. At least one of a number of threshold sets may be associated with another service (mMTC) or a combination with another service (eMBB and mMTC).

For example, when configuration information for eMBB and configuration information for URLLC are specified in the specification, the case where the UE supports eMBB alone may be the case where the UE supports the eMBB configuration information alone. The case where the UE supports URLLC alone may be the case where the UE supports the URLLC configuration information alone. The case where the UE supports both eMBB and URLLC may be the case where the UE supports both the eMBB configuration information and the URLLC configuration information.

<Option 1-2>

One threshold set may be selected from a number of threshold sets based on the service the UE is configured with.

Given two threshold sets, the UE may select different threshold sets depending on whether or not the UE is configured with URLLC alone. To say that UE is configured with URLLC alone may mean that the UE is configured with the functions for URLLC (URLLC configuration information) alone. For example, assuming the case where configuration information for eMBB and configuration information for URLLC are specified in the specification, to say that UE supports URLLC alone may mean that the UE is configured to use the URLLC configuration information alone.

Also, given two threshold sets, the UE may select different threshold sets depending on whether or not the UE is configured with eMBB alone. To say that UE is configured with eMBB alone may mean that the UE is configured with the functions for eMBB (eMBB configuration information) alone. For example, assuming the case where configuration information for eMBB and configuration information for URLLC are specified in the specification, to say that UE supports eMBB alone may mean that the UE is configured to use the eMBB configuration information alone.

Furthermore, the UE may select a threshold set associated with a service or a combination of services the UE is configured with, from a number of threshold sets. For example, three threshold sets may be associated with the case where the UE is configured with eMBB alone, the case where the UE is configured with URLLC alone, and the case where the UE is configured with both eMBB and URLLC, respectively. To say that UE is configured with both eMBB and URLLC may mean that the UE is configured with both the functions for eMBB and the functions for URLLC. At least one of a number of threshold sets may be associated with another service (mMTC) or a combination with another service (eMBB and mMTC).

For example, when configuration information for eMBB and configuration information for URLLC are specified in the specification, the case where the UE is configured with eMBB alone may be the case where the UE is configured with the eMBB configuration information alone. The case where the UE is configured with URLLC alone may be the case where the UE is configured with the URLLC configuration information alone. The case where the UE is configured with both eMBB and URLLC may be the case where the UE is configured with both the eMBB configuration information and the URLLC configuration information.

<Option 1-3>

The NW may configure UE with one of a number of threshold sets. This one threshold set may be configured by at least one of higher layer signaling and physical layer signaling.

The NW may select one from a number of threshold sets based on UE capabilities (as in option 1-1). The NW may select one of a number of threshold sets based on the service the UE is configured with (as in option 1-2).

<Option 1-4>

When UE is configured with a number of threshold sets, the UE may report a determination result (IS or OOS) for each of the threshold sets.

The NW receives a number of determination results that respectively correspond to the threshold sets. The NW may use one reporting result, among a number of determination results, based on UE capabilities (as in option 1-1), or based on the service the UE is configured with (as in option 1-2). Also, the NW may use all of a number of determination results.

When the UE is configured with two threshold sets, the UE may report the IS or the OOS for each of the two threshold sets. For example, when one of the two threshold sets is the threshold set for URLLC and the other one is the threshold set for eMBB, the UE may report IS or OOS by using the threshold set for URLLC, and also report IS or OOS by using the threshold set for eMBB.

According to the first example, appropriate Qᵢₙ and Qₒᵤₜ can be configured for the UE that uses at least one of a number of services with different requirements. Therefore, the UE can perform appropriate RLM depending on services.

### Second Example

A second example of the present invention will describe the requirements for beam failure detection.

To provide threshold sets corresponding to Q_{in, LR} and Q_{out, LR}, a number of threshold sets may be defined in advance by the specification, or may be configured from the NW. These threshold sets may be configured by at least one of higher layer signaling and physical layer signaling. For example, the threshold sets may be thresholds for the BLER and L1-RSRP that correspond to Q_{out, LR} and Q_{in, LR}, respectively.

One of following options 2-1 to 2-4 may be used for a number of services (for example, eMBB, URLLC, etc.).

<Option 2-1>

One threshold set may be selected from a number of threshold sets, per serving cell, based on UE capabilities.

Given two threshold sets, UE may select a different threshold set, per serving cell, depending on whether or not the UE supports URLLC alone.

Furthermore, the UE may select a different threshold set from the two threshold sets, per serving cell, depending on whether or not the UE supports eMBB alone.

The UE may select, per serving cell, threshold sets associated with a service or combination of services which the UE supports, from a number of threshold sets. For example, three threshold sets may be associated with the case where the UE supports eMBB alone, the case where the UE supports URLLC alone, and the case where the UE supports both eMBB and URLLC, respectively.

<Option 2-2>

One threshold set may be selected from a number of threshold sets, per serving cell, based on the service that is configured.

Given two threshold sets, UE may select a different threshold set from the two threshold sets, per serving cell, depending on whether or not the UE is configured with URLLC alone.

The UE may select a different threshold set from two threshold sets, per serving cell, depending on whether or not the UE is configured with eMBB alone.

The UE may select, per serving cell, threshold sets associated with a service or combination of services the UE is configured with, from a number of threshold sets. For example, three threshold sets may be associated with the case where the UE is configured with eMBB alone, the case where the UE is configured with URLLC alone, and the case where the UE is configured with both eMBB and URLLC, respectively.

<Option 2-3>

The NW may configure UE with one of a number of threshold sets. This one threshold set may be configured by at least one of higher layer signaling and physical layer signaling.

The NW may select one from a number of threshold sets based on UE capabilities (as in option 2-1). The NW may select one of a number of threshold sets based on the service the UE is configured with (as in option 2-2).

<Option 2-4>

When the UE is configured with a number of threshold sets, the UE may report IS or OOS using all of a number of threshold sets (for example, both of two threshold sets).

The NW receives a number of determination results that respectively correspond to the threshold sets. The NW may use one reporting result, among a number of determination results, based on UE capabilities (as in option 1-1), or based on the service the UE is configured with (as in option 1-2). Also, the NW may use all of a number of determination results.

When UE is configured with two threshold sets, the UE may report IS or OOS for each of the two threshold sets. For example, when one of the two threshold sets is the threshold set for URLLC and the other one is the threshold set for eMBB, the UE may report the IS or the OOS using the threshold set for URLLC, and also report the IS or the OOS using the threshold set for eMBB.

According to the second example, appropriate Q_{in, LR} and Q_{out, LR} can be configured for the UE that uses at least one of a number of services with different requirements. Therefore, the UE can perform appropriate beam failure detection depending on services.

Note that, instead of the threshold sets of the first example corresponding to Qᵢₙ and Qₒᵤₜ, or instead of the threshold sets of the second example corresponding to Q_{in, LR} and Q_{out, LR}, threshold sets to combine these and correspond to Qᵢₙ, Qₒᵤₜ, LR, Q_{in, LR}, and Q_{out, LR} may be used.

(Radio Communication System)

Now, the structure of a radio communication system according to the present embodiment will be described below. In this radio communication system, communication is performed using at least one of the above examples or a combination of them.

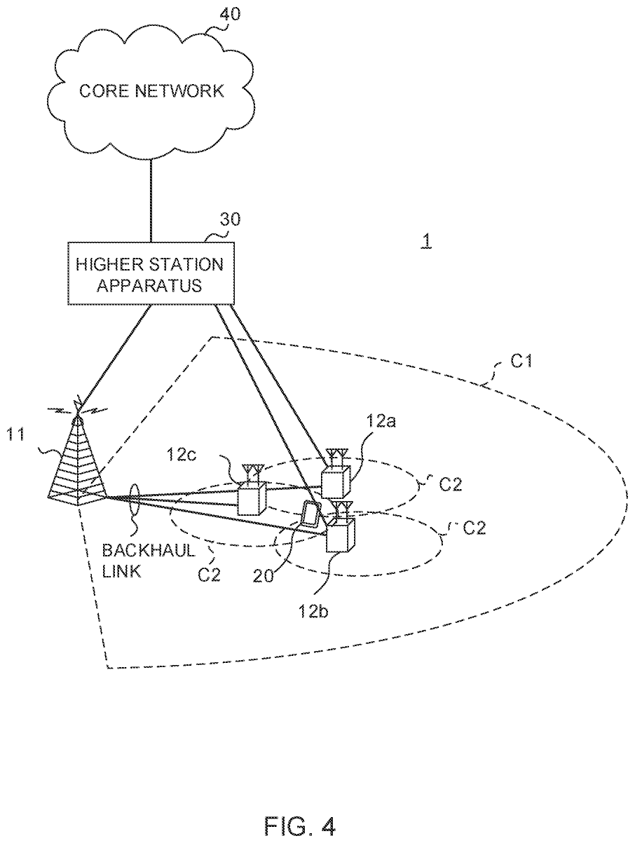

FIG. 4 is a diagram to show an exemplary schematic structure of a radio communication system according to the present embodiment. A radio communication system 1 can adopt carrier aggregation (CA) and/or dual connectivity (DC) to group a number of fundamental frequency blocks (component carriers) into one, where the LTE system bandwidth (for example, 20 MHz) constitutes one unit.

Note that the radio communication system 1 may be referred to as “LTE (Long-term evolution),” “LTE-A (LTE-Advanced),” “LTE-B (LTE-Beyond),” “SUPER 3G,” “IMT-Advanced,” “4G (4th generation mobile communication system),” “5G (5th generation mobile communication system),” “NR (New Radio),” “FRA (Future Radio Access),” “New-RAT (Radio Access Technology),” and so on, or may be seen as a system to implement these.

The radio communication system 1 includes a radio base station 11 that forms a macro cell C1, with a relatively wide coverage, and radio base stations 12 (12a to 12c) that are placed within the macro cell C1 and that form small cells C2 which are narrower than the macro cell C1. Also, user terminals 20 are placed in the macro cell C1 and in each small cell C2. The arrangement and number of cells and user terminals 20 and so forth are not limited to those illustrated in the drawings.

The user terminals 20 can connect with both the radio base station 11 and the radio base stations 12. The user terminals 20 might use the macro cell C1 and the small cells C2 at the same time by means of CA or DC. Furthermore, the user terminals 20 may apply CA or DC using a number of cells (CCs) (for example, five or fewer CCs or six or more CCs).

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the structure of the frequency band for use in each radio base station is by no means limited to these.

Furthermore, the user terminals 20 can communicate by using time division duplexing (TDD) and/or frequency division duplexing (FDD), in each cell. Furthermore, in each cell (carrier), a single numerology may be used, or a number of different numerologies may be used.

A numerology may refer to a communication parameter that is applied to transmission and/or receipt of a given signal and/or channel, and represent at least one of the subcarrier spacing, the bandwidth, the duration of symbols, the length of cyclic prefixes, the duration of subframes, the length of TTIs, the number of symbols per TTI, the radio frame configuration, the filtering process, the windowing process, and so on.

The radio base station 11 and a radio base station 12 (or two radio base stations 12) may be connected with each other by cables (for example, by optical fiber, which is in compliance with the CPRI (Common Public Radio Interface), the X2 interface and so on), or by radio.

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility, management entity (MME) and so on, but these are by no means limiting. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. Also, the radio base stations 12 are radio base stations each having a local coverage, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter, the radio base stations 11 and 12 will be collectively referred to as “radio base stations 10,” unless specified otherwise.

The user terminals 20 are terminals that support various communication schemes such as LTE, LTE-A and so on, and may be either mobile communication terminals (mobile stations) or stationary communication terminals (fixed stations).

In the radio communication system 1, as radio access schemes, orthogonal frequency division multiple access (OFDMA) is applied to the downlink, and single-carrier frequency division multiple access (SC-FDMA) and/or OFDMA are applied to the uplink.

OFDMA is a multi-carrier communication scheme to perform communication by dividing a frequency bandwidth into a number of narrow frequency bandwidths (subcarriers) and mapping data to each subcarrier. SC-FDMA is a single-carrier communication scheme to mitigate interference between terminals by dividing the system bandwidth into bands that are each formed with one or contiguous resource blocks, per terminal, and allowing a number of terminals to use mutually different bands. Note that the uplink and downlink radio access schemes are not limited to the combinations of these, and other radio access schemes may be used as well.

In the radio communication system 1, a downlink shared channel (PDSCH (Physical Downlink Shared CHannel)), which is used by each user terminal 20 on a shared basis, a broadcast channel (PBCH (Physical Broadcast CHannel)), downlink L1/L2 control channels and so on are used as downlink channels. User data, higher layer control information, SIBs (System Information Blocks) and so on are communicated in the PDSCH. Also, the MIB (Master Information Blocks) is communicated in the PBCH.

The L1/L2 control channels include at least one of DL control channels (such as a PDCCH (Physical Downlink Control CHannel) and/or an EPDCCH (Enhanced Physical Downlink Control CHannel)), a PCFICH (Physical Control Format Indicator CHannel), and a PHICH (Physical Hybrid-ARQ Indicator CHannel). Downlink control information (DCI), which includes PDSCH and/or PUSCH scheduling information and so on, is communicated by the PDCCH.

Note that scheduling information may be reported in DCI. For example, the DCI to schedule receipt of DL data may be referred to as “DL assignment,” and the DCI to schedule transmission of UL data may also be referred to as “UL grant.”

The number of OFDM symbols to use for the PDCCH is communicated by the PCFICH. HARQ (Hybrid Automatic Repeat reQuest) delivery acknowledgment information (also referred to as, for example, “retransmission control information,” “HARQ-ACKs,” “ACK/NACKs,” etc.) in response to the PUSCH is transmitted by the PHICH. The EPDCCH is frequency-division-multiplexed with the PDSCH (downlink shared data channel) and used to communicate DCI and so on, like the PDCCH.

In the radio communication system 1, an uplink shared channel (PUSCH (Physical Uplink Shared CHannel)), which is used by each user terminal 20 on a shared basis, an uplink control channel (PUCCH (Physical Uplink Control CHannel)), a random access channel (PRACH (Physical Random Access CHannel)) and so on are used as uplink channels. User data, higher layer control information and so on are communicated by the PUSCH. Also, in the PUCCH, downlink radio quality information (CQI (Channel Quality Indicator)), delivery acknowledgment information, scheduling requests (SRs) and so on are communicated. By means of the PRACH, random access preambles for establishing connections with cells are communicated.

In the radio communication system 1, cell-specific reference signals (CRSs), channel state information reference signals (CSI-RSs), demodulation reference signals (DMRSs), positioning reference signals (PRSs) and so on are communicated as downlink reference signals. Also, in the radio communication system 1, measurement reference signals (SRSs (Sounding Reference Signals)), demodulation reference signals (DMRSs) and so on are communicated as uplink reference signals. Note that the DMRSs may be referred to as “user terminal-specific reference signals (UE-specific reference signals).” Also, the reference signals to be communicated are by no means limited to these.

(Radio Base Station)

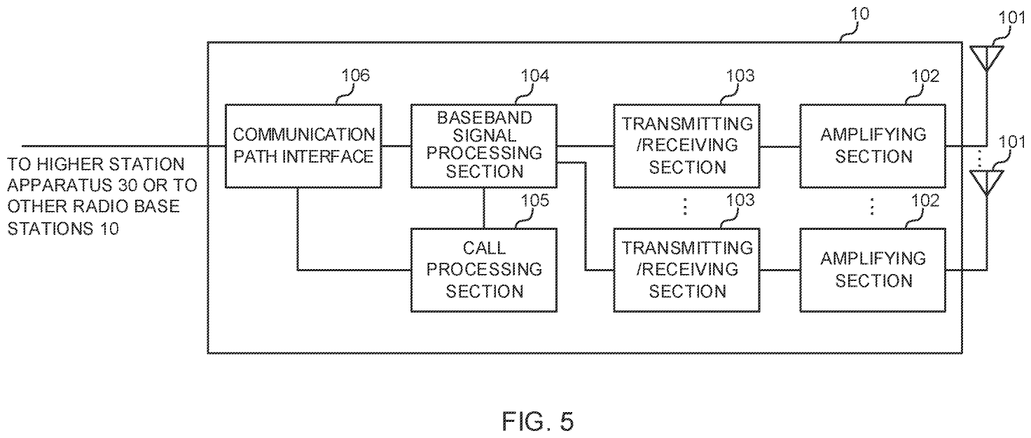

FIG. 5 is a diagram to show an exemplary overall structure of a radio base station according to the present embodiment. A radio base station 10 has a number of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30, to the baseband signal processing section 104, via the communication path interface 106.

In the baseband signal processing section 104, the user data is subjected to transmission processes, including a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a preceding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base station 10, and manages the radio resources.

The communication path interface section 106 transmits and receives signals to and from the higher station apparatus 30 via a given interface. Also, the communication path interface 106 may transmit and receive signals (backhaul signaling) with other radio base stations 10 via an inter-base station interface (which is, for example, optical fiber that is in compliance with the CPRI (Common Public Radio Interface), the X2 interface, etc.).

Note that the transmitting/receiving sections 103 may furthermore have an analog beamforming section where analog beamforming takes place. The analog beamforming section may be constituted by an analog beamforming circuit (for example, a phase shifter, a phase shifting circuit, etc.) or analog beamforming apparatus (for example, a phase shifting device) that can be described based on general understanding of the technical field to which the present invention pertains. Furthermore, the transmitting/receiving antennas 101 may be constituted by, for example, array antennas. In addition, the transmitting/receiving sections 103 are designed so that single-BF or multiple-13F operations can be used.

The transmitting/receiving sections 103 may transmit signals by using transmitting beams, or receive signals by using receiving beams. The transmitting/receiving sections 103 may transmit and/or receive signals by using given beams determined by the control section 301.

Furthermore, the transmitting/receiving sections 103 may receive a beam failure recovery request (for example, a BFR request) or transmit a response to a beam failure recovery request (for example, a BFR request response).

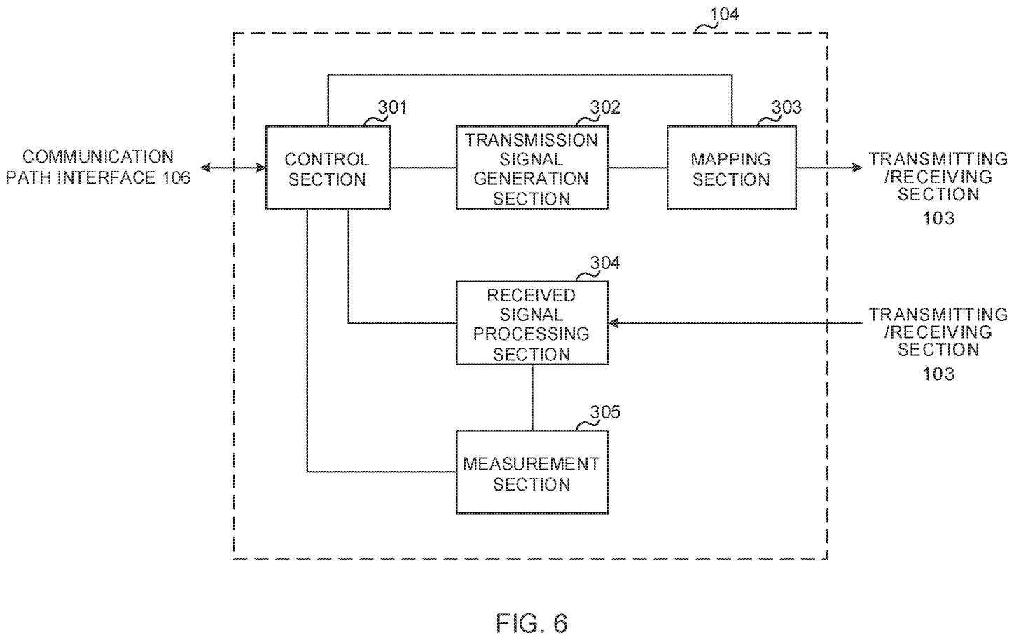

FIG. 6 is a diagram to show an exemplary functional structure of a radio base station according to the present embodiment. Note that, although this example primarily shows functional blocks that pertain to characteristic parts of the present embodiment, the radio base station 10 might have other functional blocks that are necessary for radio communication as well.

The baseband signal processing section 104 at least has a control section (scheduler) 301, a transmission signal generation section 302, a mapping section 303, a received signal processing section 304 and a measurement section 305. Note that these configurations have only to be included in the radio base station 10, and some or all of these configurations may not be included in the baseband signal processing section 104.

The control section (scheduler) 301 controls the whole of the radio base station 10. The control section 301 can be constituted by a controller, a control circuit or control apparatus that can be described based on general understanding of the technical field to which the present invention pertains.

The control section 301 controls, for example, generation of signals in the transmission signal generation section 302, allocation of signals in the mapping section 303, and so on. Furthermore, the control section 301 controls signal receiving processes in the received signal processing section 304, measurements of signals in the measurement section 305, and so on.

The control section 301 controls the scheduling (for example, resource allocation) of system information, downlink data signals (for example, signals transmitted in the PDSCH) and downlink control signals (for example, signals transmitted in the PDCCH and/or the EPDCCH, such as delivery acknowledgment information). Also, the control section 301 controls the generation of downlink control signals, downlink data signals, and so on based on the results of deciding whether or not retransmission control is necessary for uplink data signals, and so on.

The control section 301 controls scheduling of synchronization signals (for example, PSS/SSS), downlink reference signals (for example, CRS, CSI-RS, DMRS, etc.) and the like.

The control section 301 may exert control so that transmitting beams and/or receiving beams are formed by using digital BF (for example, precoding) iii the baseband signal processing section 104 and/or analog BF (for example, phase rotation) in the transmitting/receiving sections 103.

The control section 301 may control radio link monitoring (RLM) and/or beam recovery (BR) for the user terminal 20.

Furthermore, the control section 301 may control the receipt of comparison results between at least one threshold set among a number of threshold sets with a value that is based on the receipt of a downlink signal. These threshold sets may be associated with a number of communication requirements, respectively. These threshold sets may each include a number of thresholds for at least one of radio link monitoring and beam failure detection.

The transmission signal generation section 302 generates downlink signals (downlink control signals, downlink data signals, downlink reference signals, and so on) based on commands from the control section 301, and outputs these signals to the mapping section 303. The transmission signal generation section 302 can be constituted by a signal generator, a signal generating circuit or signal generating apparatus that can be described based on general understanding of the technical field to which the present invention pertains.

For example, the transmission signal generation section 302 generates DL assignments, which report downlink data allocation information, and/or UL grants, which report uplink data allocation information, based on commands from the control section 301. DL assignments and UL grants are both DCI, in compliance with DCI format. Also, the downlink data signals are subjected to the coding process, the modulation process and so on, by using coding rates, modulation schemes and the like that are determined based on, for example, channel state information (CSI) from each user terminal 20.

The mapping section 303 maps the downlink signals generated in the transmission signal generation section 302 to given radio resources based on commands from the control section 301, and outputs these to the transmitting/receiving sections 103. The mapping section 303 can be constituted by a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminal 20 (uplink control signals, uplink data signals, uplink reference signals, etc.). The received signal processing section 304 can be constituted by a signal processor, a signal processing circuit or signal processing apparatus that can be described based on general understanding of the technical field to which the present invention pertains.

The received signal processing section 304 outputs the decoded information acquired through the receiving processes, to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signals. The measurement section 305 can be constituted by a measurer, measurement circuit or measurement apparatus that can be described based on general understanding of the technical field to which the present invention pertains.

For example, the measurement section 305 may perform RRM (Radio Resource Management) measurements, CSI (Channel State Information) measurements, and so on, based on the received signals. The measurement section 305 may measure the received power (for example, RSRP (Reference Signal Received Power)), the received quality (for example, RSRQ (Reference Signal Received Quality), SINK (Signal to Interference plus Noise Ratio), SNR (Signal to Noise Ratio), etc.), the signal strength (for example, RSSI (Received Signal Strength indicator)), transmission path information (for example, CSI) and so on. The measurement results may be output to the control section 301.

(User Terminal)

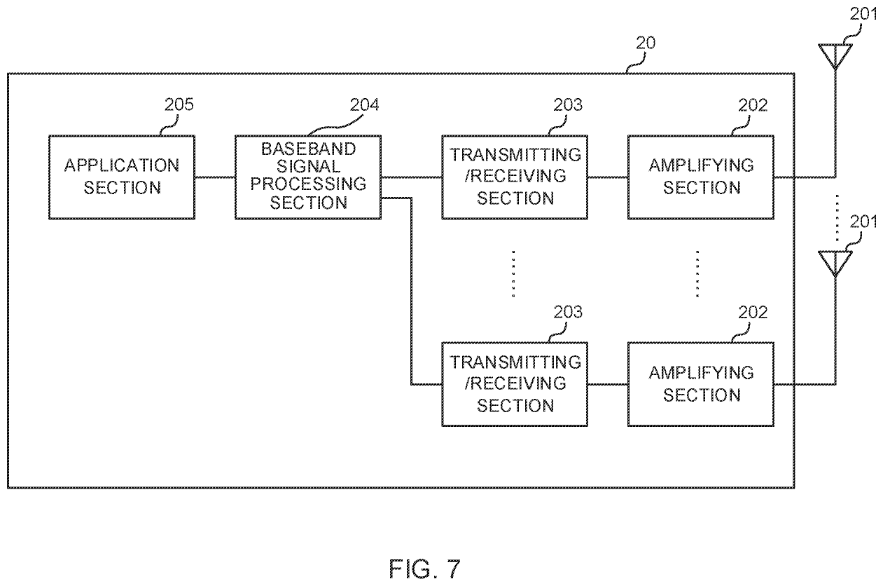

FIG. 7 is a diagram to show an exemplary overall structure of a user terminal according to the present embodiment, A user terminal 20 has a number of transmitting/receiving antennas 201, amplifying sections 202, transmitting/receiving sections 203, a baseband signal processing section 204, and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present invention pertains. Note that a transmitting/receiving section 203 may be structured as a transmitting/receiving section in one entity, or may be constituted by a transmitting section and a receiving section.

The baseband signal processing section 204 performs, for the baseband signal that is input, an FFT process, error correction decoding, a retransmission control receiving process, and so on. Downlink user data is forwarded to the application section 205. The application section 205 performs processes related to higher layers above the physical layer and the MAC layer, and so on. Also, in the downlink data, the broadcast information can be also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving sections 203.

Baseband signals that are output from the baseband signal processing section 204 are converted into a radio frequency band in the transmitting/receiving sections 203, and transmitted. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 may further have an analog beamforming section where analog beamforming takes place. The analog beamforming section may be constituted by an analog beamforming circuit (for example, a phase shifter, a phase shifting circuit, etc.) or analog beamforming apparatus (for example, a phase shifting device) that can be described based on general understanding of the technical field to which the present invention pertains. Furthermore, the transmitting/receiving antennas 201 may be constituted by, for example, array antennas. In addition, the transmitting/receiving sections 203 are structured so that single-BF and multiple-BF can be used.

The transmitting/receiving sections 203 may transmit signals by using transmitting beams, or receive signals by using receiving beams. The transmitting/receiving sections 203 may transmit and/or receive signals by using given beams selected by the control section 401.

Furthermore, the transmitting/receiving sections 203, may transmit a beam failure recovery request (for example, a BFR request) when detecting a beam failure, or receive a response to a beam failure recovery request (for example, a BFR request response).

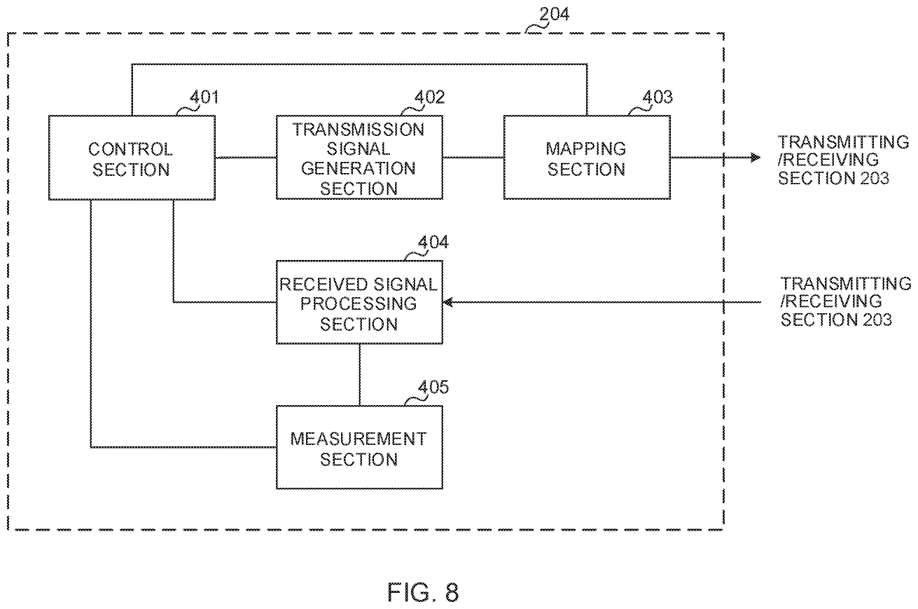

FIG. 8 is a diagram to show an exemplary functional structure of a user terminal according to the present embodiment. Note that, although this example primarily shows functional blocks that pertain to characteristic parts of present embodiment, the user terminal 20 might have other functional blocks that are necessary for radio communication as well.

The baseband signal processing section 204 provided in the user terminal 20 at least has a control section 401, a transmission signal generation section 402, a mapping section 403, a received signal processing section 404, and a measurement section 405. Note that these configurations have only to be included in the user terminal 20, and some or all of these configurations may not be included in the baseband signal processing section 204.

The control section 401 controls the whole of the user terminal 20. The control section 401 can be constituted by a controller, a control circuit or control apparatus that can be described based on general understanding of the technical field to which the present invention pertains.

The control section 401 controls, for example, generation of signals in the transmission signal generation section 402, allocation of signals in the mapping section 403, and so on. Furthermore, the control section 401 controls signal receiving processes in the received signal processing section 404, measurements of signals in the measurement section 405, and so on.

The control section 401 acquires the downlink control signals and downlink data signals transmitted from the radio base station 10, via the received signal processing section 404. The control section 401 controls the generation of uplink control signals and/or uplink data signals based on results of deciding whether or not retransmission control is necessary for the downlink control signals and/or downlink data signals, and so on.

The control section 401 may exert control so that transmitting beams and/or receiving beams are formed by using digital BF (for example, precoding) in the baseband signal processing section 204 and/or by using analog BF (for example, phase rotation) in the transmitting/receiving sections 203.

The control section 401 may control radio link monitoring (RLM) and/or beam recovery (BR) based on measurement results in the measurement section 405.

Also, the control section 401 may compare at least one threshold set among a number of threshold sets with a value that is based on the receipt of a downlink signal. These threshold sets may be associated with a number of communication requirements, respectively. These threshold sets may each include a number of thresholds for at least one of radio link monitoring and beam failure detection.

Furthermore, the control section 401 may use one threshold set for the above comparison, among the above threshold sets, based on whether or not a user terminal supports a given communication requirement or based on whether or not the user terminal is configured with a given communication requirement.

Also, the transmitting/receiving sections 203 may receive information to indicate one of the threshold sets. The control section 401 may use the threshold set, indicated by the information, for the above comparison.

Furthermore, the control section 401 may compare each of the threshold sets with a value that is based on a downlink signal, and control the reporting of a number of comparison results that are respectively based on the threshold sets.

In addition, the threshold sets may each include two thresholds for beam failure detection. The control section 401 may use at least one threshold set among the threshold sets, per serving cell, for the above comparison.

The transmission signal generation section 402 generates uplink signals (uplink control signals, uplink data signals, uplink reference signals, etc.) based on commands from the control section 401, and outputs these signals to the mapping section 403. The transmission signal generation section 402 can be constituted by a signal generator, a signal generating circuit, or signal generation apparatus that can be described based on general understanding of the technical field to which the present invention pertains.

For example, the transmission signal generation section 402 generates uplink control signals such as delivery acknowledgement information, channel state information (CSI) and so on, based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and outputs these to the transmitting/receiving sections 203. The mapping section 403 can be constituted by a mapper, a mapping circuit or mapping apparatus that can be described based on general understanding of the technical field to which the present invention pertains.

The received signal processing section 404 performs receiving processes (for example, demapping, demodulation, decoding and so on) for received signals that are input from the transmitting/receiving sections 203. Here, the received signals include, for example, downlink signals (downlink control signals, downlink data signals, downlink reference signals, and so on) that are transmitted from the radio base station 10. The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present disclosure.

The received signal processing section 404 outputs the decoded information acquired through the receiving processes, to the control section 401. The received signal processing section 404 outputs, for example, broadcast information, system information, RRC signaling, DCI and so on, to the control section 401. Also, the received signal processing section 404 outputs the received signals and/or the signals after the receiving processes to the measurement section 405.

The measurement section 405 conducts measurements with respect to the received signals. The measurement section 405 can be constituted by a measurer, a measurement circuit or measurement apparatus that can be described based on general understanding of the technical field to which the present invention pertains.

For example, the measurement section 405 may perform RRM measurements, CSI measurements, and so on, based on the received signals. The measurement section 405 may measure the received power (for example, RSRP), the received quality (for example, RSRQ, SINR, SNR, etc.), the signal strength (for example, RSSI), transmission path information (for example, CSI), and so on. The measurement results may be output to the control section 401.

(Hardware Structure)

Note that the block diagrams that have been used to describe the above embodiment show blocks in functional units. These functional blocks (components) may be implemented in arbitrary combinations of at least one of hardware and software. Also, the method for implementing each functional block is not particularly limited. That is, each functional block may be implemented by one piece of apparatus that is physically or logically aggregated, or may be implemented by connecting wo or more physically or logically-separate pieces of apparatus directly or indirectly (by using cables or radio; for example) and using these pieces of apparatus.

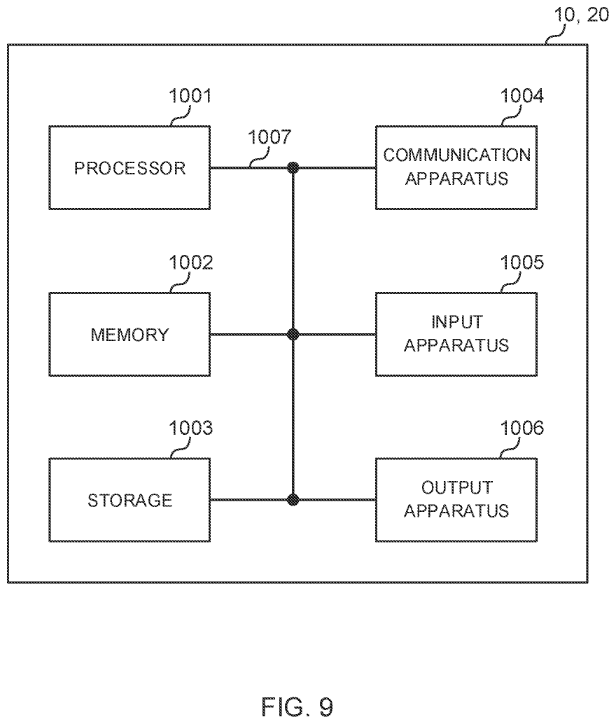

For example, the radio base stations, user terminals and so on according to one embodiment of this disclosure may function as a computer that executes the processes of the radio communication method of the present disclosure. FIG. 9 is a diagram to show an example hardware structure of a radio base station and a user terminal according to one embodiment. Physically, the above-described radio base stations 10 and user terminals 20 may be formed as a computer apparatus that includes a processor 1001, a memory 1002, a storage 1003, communication apparatus 1004, input apparatus 1005, output apparatus 1006, a bus 1007 and so on.

Note that, in the following description, the term “apparatus” may be replaced by “circuit,” “device,” “unit” and so on. The hardware structure of a radio base station 10 and a user terminal 20 may be designed to include one or more of each apparatus shown in the drawings, or may be designed not to include part of the apparatus.

For example, although only one processor 1001 is shown, a plurality of processors may be provided. Furthermore, processes may be executed with one processor, or processes may be executed simultaneously or in sequence, or processes may be executed by using different techniques, on two or more processors. Note that the processor 1001 may be implemented with one or more chips.

The functions of the radio base station 10 and the user terminal 20 are implemented by, for example, allowing hardware such as the processor 1001 and the memory 1002 to read given software (programs), and allowing the processor 1001 to do calculations, control communication that involves the communication apparatus 1004, and control at least one of the reading and writing of data in the memory 1002 and the storage 1003.

The processor 1001 may control the whole computer by, for example, running an operating system. The processor 1001 may be constituted by a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data, and so forth from at least one of the storage 1003 and the communication apparatus 1004, into the memory 1002, and executes various processes in accordance with these. As for the programs, programs to allow computers to execute at least part of the operations of the above-described embodiment may be used. For example, the control section 401 of a user terminal 20 may be implemented by control programs that are stored in the memory 1002 and that operate on the processor 1001, and other functional locks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory), and other appropriate storage media. The memory 1002 may be referred to as a “register,” a “cache,” a “main memory (primary storage apparatus),” and so on. The memory 1002 can store executable programs (program codes), software modules and so forth for implementing the radio communication methods according to one embodiment of this disclosure.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) or the like), a digital versatile disc, a Blu-ray (registered trademark) disk, etc.), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using at least one of a cable network and a wireless network, and may be referred to as, for example, a “network device,” a “network controller,” a “network card,” a “communication module,” and so on. The communication apparatus 1004 may be configured to include a high frequency switch, a duplexer, a filter, a frequency synthesizer and so on, in order to implement, for example, at least one of frequency division duplex (FDD) and time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from outside (for example, a keyboard, a mouse, a microphone, a switch, a button, a sensor and so on). The output apparatus 1006 is an output device for executing output to outside (for example, a display, a speaker, an LED (Light Emitting Diode) lamp, and so on), Note that the input apparatus 1005 and the output apparatus 1006 may be provided in an integrated structure (for example, a touch panel).

Furthermore, these pieces of apparatus, including the processor 1001, the memory 1002 and so on, are connected by the bus 1007, so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable t Device), an FPGA (Field Programmable Gate Array) and so on, and part or all of the functional blocks may be implemented by these pieces of hardware. For example, the processor 1001 may be implemented with at least one of these pieces of hardware.

(Variations)

Note that the terminology used in the present disclosure and the terminology that is needed to understand the present disclosure may be replaced by terms that communicate the same or similar meanings. For example, at least one of a channel and a symbol may be a signal (signaling). Also, a signal may be a message. A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency,” and so on.

A radio frame may be comprised of one or more periods (frames) in the time domain. One or more periods (frames) that constitute a radio frame may be each referred to as a “subframe.” Furthermore, a subframe may be comprised of one or more slots in the time domain. A subframe may be a fixed time duration (for example, 1 ms), which does not depend on a numerology.

Here, a numerology may refer to a communication parameter that is applied to at least one of transmission and receipt of a given signal or channel. For example, a numerology may represent at least one of the subcarrier spacing (SCS), the bandwidth, the length of symbols, the length of cyclic prefix, the transmission time interval (TTI), the number of symbols per TTI, the radio frame configuration, a specific filtering process which the transmitter/receiver performs in the frequency domain, a specific windowing process which the transmitter/receiver performs in the time domain, and so forth.

A slot may be comprised of one or more symbols in the time domain (OFDM (Orthogonal Frequency Division Multiplexing) symbols, SC-FDMA (Single Carrier Frequency Division Multiple Access) symbols, and so on). Also, a slot may be a time unit based on numerology.

Also, a slot may include a plurality of minislots. Each minislot may be comprised of one or more symbols in the time domain. Also, a minislot may be referred to as a “subslot.” A minislot may be comprised of fewer symbols than a slot. A PDSCH (or PUSCH) that is transmitted in a larger time unit than a minislot may be referred to as “PDSCH (PUSCH) mapping type A.” A PDSCH (or a PUSCH) that is transmitted using a minislot may be referred to as “PDSCH (PUSCH) mapping type B.”

A radio frame, a subframe, a slot, a minislot, and a symbol all refer to a unit of time in signal communication. A radio frame, a subframe, a slot, a minislot and a symbol may be each called by other applicable names.

For example, one subframe may be referred to as a “transmission time interval (TTI),” or a plurality of consecutive subframes may be referred to as a “TTI,” or one slot or one minislot may be referred to as a “TTI.” That is, at least one of a subframe and a TTI may be a subframe (1 ms) in existing LTE, may be a shorter period than 1 ms (for example, one to thirteen symbols), or may be a longer period than 1 ms. Note that the unit to represent a TTI may be referred to as a “slot,” a “minislot” and so on, instead of a “subframe.”

Here, a TTI refers to the minimum time unit for scheduling in radio communication, for example. For example, in LTE systems, a radio base station schedules the radio resources (such as the frequency bandwidth and transmission power each user terminal can use) to allocate to each user terminal in TTI units. Note that the definition of TTIs is not limited to this.

A TTI may be the time unit for transmitting a channel-encoded data packet (transport block), a code block, a codeword, and so on or may be the unit of processing in scheduling, link adaptation, and so on. Note that, when a TTI is given, the period of time (for example, the number of symbols) in which a transport block, a code block and a codeword is actually mapped may be shorter than the TTI.

Note that, when one slot or one minislot is referred to as a “TTI,” one or more TTIs (that is, one or more slots or one or more minislots) may be the minimum time unit of scheduling. Also, the number of slots (the number of minislots) to constitute this minimum time unit for scheduling may be controlled.

A TTI having a time duration of 1 ms may be referred to as a “normal TTI” (TTI in LTE Rel. 8 to 12), a “long TTI,” a “normal subframe,” a “long subframe,” a “slot,” and so on. A FIE that is shorter than a normal may be referred to as a “shortened TTI,” a “short TTI,” a “partial TTI” (or a “fractional TTI”), a “shortened subframe,” a “short subframe,” a “minislot,” a “sub-slot,” a “slot,” and so on.

Note that a long TTI (for example, a normal TTI, a subframe, etc.) may be replaced with a TTI having a time duration exceeding 1 ms, and a short TTI (for example, a shortened TTI) may be replaced with a having a TTI length less than the length of a long TTI and not less than 1 ms.

A resource block (RB) is the unit of resource allocation in the time domain and the frequency domain, and may include one or a plurality of consecutive subcarriers in the frequency domain.

Also, an RB may include one or more symbols in the time domain, and may be one slot, one minislot, one subframe or one TTI in length. One TTI and one subframe each may be comprised of one or more resource blocks.

Note that one or more RBs may be referred to as a “physical resource block (PRB (Physical RB)),” a “subcarrier group (SCG),” a “resource element group (REG),” a “PRB pair,” an “RB pair,” and so on.

Furthermore, a resource block may be comprised of one or more resource elements (REs). For example, one RE may be a radio resource field of one subcarrier and one symbol.

Note that the structures of radio frames, subframes, slots, minislots, symbols, and so on described above are simply examples. For example, configurations pertaining to the number of subframes included in a radio frame, the number of slots included in a subframe or a radio frame, the number of minislots included in a slot, the number of symbols and PCBs included in a slot or a minislot, the number of subcarriers included in an RB, the number of symbols in a TTI, the length of symbols, the length of cyclic prefix (CP), and so on can be variously changed.

Also, the information and parameters described in the present disclosure may be represented in absolute values or in relative values with respect to given values, or may be represented using other applicable information. For example, a radio resource may be indicated by a given index.

The names used for parameters and so on in the present disclosure are in no respect limiting. In addition, equations and the like to use these parameters may be used, apart from those explicitly disclosed in the present disclosure. Since a variety of channels (PUCCH (Physical Uplink Control CHannel), PDCCH (Physical Downlink Control CHannel) and so on) and information elements can be identified by any suitable names, the various names assigned to these individual channels and information elements are in no respect limiting.

The information, signals and/or others described in the present disclosure may be represented by using any of a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output, either at least, from higher layers to lower layers and from lower layers to higher layers. Information, signals, and so on may be input and/or output via a plurality of network nodes.

The information, signals, and so on that are input and/or output may be stored in a specific location (for example, in a memory), or may be managed in a control table. The information, signals, and so on to be input and/or output can be overwritten, updated, or appended. The information, signals, and so on that are output may be deleted. The information, signals, and so on that are input may be transmitted to other pieces of apparatus.

Reporting of information is by no means limited to the examples/embodiments described in the present disclosure, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBs) and so on), MAC (Medium Access Control) signaling, etc.), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as “RRC messages,” and can be, for example, an “RRC connection setup message,” “RRC connection reconfiguration message,” and so on. Also, MAC signaling may be reported using, for example, MAC control elements (MAC CEs (Control Elements)).

Also, reporting of given information (for example, reporting of information to the effect that “X holds”) does not necessarily have to be sent explicitly, and can be sent in an implicit way (for example, by not reporting this piece of information, or by reporting another piece of information).

Decisions may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions, and so on.

Also, software, instructions, information and so on may be transmitted and received via communication media. For example, when software is transmitted from a website, a server or other remote sources by using at least one of wired technologies (coaxial cables, optical fiber cables, twisted-pair cables, digital subscriber lines (DSL) and so on), and wireless technologies (infrared radiation, microwaves, and so on), at least one of these wired technologies and wireless technologies are also included in the definition of communication media.

The terms “system” and “network” as used in the present disclosure are used interchangeably.

Terms such as “base station (BS),” “radio base station,” “fixed station.” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and “bandwidth part (BWP)” as used in the present disclosure may be used interchangeably. A base station may also be referred to as a “macro cell,” a “small cell,” a “femto cell,” a “pi co cell,” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of at least one of a base station and a base station subsystem that provides communication services within this coverage.

As used in the present disclosure, the terms “mobile station (MS),” “user terminal,” “user equipment (UE),” “terminal” and so forth may be used interchangeably.

A mobile station may be referred to as a “subscriber station,” a “mobile unit,” a “subscriber unit,” a “wireless unit,” a “remote unit,” a “mobile device,” a “wireless device,” a “wireless communication device,” a “remote device,” a “mobile subscriber station,” a “access terminal,” a “mobile terminal,” a “wireless terminal,” a “remote terminal,” a “handset,” a “user agent,” a “mobile client,” a “client,” or some other suitable terms.

At least one of a base station and a mobile station may be referred to as “transmitting apparatus,” “receiving apparatus,” and the like. Note that at least one of a base station and a mobile station may be a device that is mounted on a mobile entity, or may be a mobile entity itself. This mobile entity may be a vehicle (for example, a car, an airplane, etc.), may be a mobile entity that moves unmanned (for example, a drone, a self-driving car, etc.) or may be a robot (manned or unmanned). Note that at least one of a base station and a mobile station includes a device that does not necessarily move during communication operation.

Furthermore, a radio base station in the present disclosure may be interpreted as a user terminal. For example, the examples/embodiments of the present disclosure may be applied to configurations in which communication between a radio base station and a user terminal is replaced with communication among a plurality of user terminals (which may be referred to as, for example, “D2D (Device-to-Device),” “V2X (Vehicle-to-Everything),” etc.). In this case, user terminals 20 may have the functions of the radio base stations 10 described above. In addition, terms such as “uplink” and “downlink” may be interpreted as words that correspond to communication between terminals (for example, “side”). For example, an “uplink channel” and a “downlink channel” may be each interpreted as a “side channel.”

Likewise, a user terminal in the present disclosure may be interpreted as a radio base station. In this case, the radio base stations 10 may have the functions of the user terminals 20 described above.

Actions that have been described in the present disclosure to be performed by base stations may, in some cases, be performed by their upper nodes. In a network comprised of one or more network nodes with base stations, it is clear that various operations that are performed to communicate with terminals can be performed by base stations, one or more network nodes (for example, MMEs (Mobility Management Entities), S-GWs (Serving-Gateways) and so on may be possible, but these are not limiting) other than base stations, or combinations of these.

The examples/embodiments illustrated in the present disclosure may be used individually or may be used in combinations, which may be switchable depending on the mode of implementation. In addition, the order of processes, sequences, flowcharts, and so on that have been used to describe the examples/embodiments in the present disclosure may be re-ordered as long as inconsistencies do not arise. For example, although a variety of methods have been illustrated in the present disclosure with various components of steps in exemplary orders, the specific orders illustrated herein are by no means limiting.

The examples/embodiments illustrated in the present disclosure may be applied to systems that use LTE (Long-term evolution), LTE-A (LTE-Advanced), UE-B (LTE-Beyond), SUPER 3G. IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), other adequate radio communication methods, and next-generation systems that are enhanced based on these. Furthermore, a number of systems may be combined (for example, a combination of LTE or LTE-A with 5G) and applied.

The phrase “based on” as used in the present disclosure does not mean “based only on” unless explicitly specified otherwise. In other words, the phrase “based on” means both “based only on” and “based at least on.”

Reference to elements with designations such as “first,” “second,” and so on as used in the present disclosure does not generally limit the number/quantity or order of these elements. These designations are used in the present disclosure only for convenience, as a method for distinguishing between two or more elements. It follows that reference to the first and second elements does not imply that only two elements may be employed, or that the first element must precede the second element in some way.

The terms “judge” and “determine” as used in the present disclosure may encompass a wide variety of actions. For example, to “judge” and “determine” as used in the present disclosure may be interpreted as meaning making judgements and determinations related to judging, calculating, computing, processing, deriving, investigating, looking up (for example, searching a table, a database, or some other data structure), ascertaining, and so on.

Furthermore, to “judge” and “determine” as used in the present disclosure may be interpreted as meaning making judgements and determinations related to receiving (for example, receiving information), transmitting (for example, transmitting information), inputting, outputting, accessing (for example, accessing data in a memory) and so on.

In addition, to “judge” and “determine” as used in the present disclosure may be interpreted as meaning making judgements and determinations related to resolving, selecting, choosing, establishing, comparing, and so on. In other words, to “judge” and “determine” as used in the present disclosure may be interpreted as meaning making judgements and determinations with regard to some action.

In addition, to “judge” and “determine” as used in the present disclosure may be interpreted as “assuming,” “expecting,” “considering,” and the like.

The “maximum transmission power” as described in the present disclosure may mean the maximum value of transmission power, the nominal maximum transmission power (the nominal UE maximum transmit power), or the rated maximum transmission power (the rated UE maximum transmit power).

As used in the present disclosure, the terms “connected” and “coupled,” or any variation of these terms, mean all the direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be interpreted as “access.”

As used in the present disclosure, when two elements are connected, these elements may be considered “connected” or “coupled” to each other by using one or more electrical wires, cables, and printed electrical connections, and, as a number of non-limiting and non-inclusive examples, by using electromagnetic energy having wavelengths of the radio frequency region, the microwave region and the optical region (both visible and invisible).

In the present disclosure, the phrase “A and B are different” may mean “A and B are different from each other.” The terms such as “leave,” “coupled” and the like may be interpreted likewise.

When terms such as “include,” “including” and variations of these are used in the present disclosure, these terms are intended to be inclusive, in a manner similar to the way the term “comprising” is used. Furthermore, the term “or” as used in the present disclosure is intended not to be an exclusive disjunction.

When articles such as “a,” “an” and “the” in English are added in the translation of this disclosure, cases in which the nouns following these articles assume plural forms may be covered within the scope of the present disclosure.

Now, although the present disclosure has been described in detail above, it should be obvious to a person skilled in the art that the present disclosure is by no means limited to the embodiments described herein. The present disclosure can be implemented with various corrections and in various modifications, without departing from the spirit and scope of the present invention defined based on the recitations of claims. Consequently, the description herein is provided only for the purpose of explaining examples, and should by no means be construed to limit the invention concerning this disclosure in any way.

1. A user terminal comprising:
a receiving section that receives a downlink signal; and
a control section that compares at least one threshold set, among a plurality of threshold sets, with a value that is based on receipt of the downlink signal, wherein:
the plurality of threshold sets are associated with a plurality of communication requirements, respectively; and
the plurality of threshold sets each include a plurality of thresholds for at least one of radio link monitoring and beam failure detection.

2. The user terminal according to claim 1, wherein the control section uses one threshold set for the comparison, among the plurality of threshold sets, based on whether or not the user terminal supports a given communication requirement or based on whether or not the user terminal is configured with the given communication requirement.

3. The user terminal according to claim 1, wherein:
the receiving section receives information indicating one threshold set, among the plurality of threshold sets; and
the control section uses the threshold set; indicated by the information, for the comparison.

4. The user terminal according to claim 1 wherein the control section compares each of the plurality of threshold sets with a value that is based on the downlink signal, and controls reporting of a plurality of comparison results that are based respectively on the plurality of threshold sets.

5. The user terminal according to claim 1, wherein:
the plurality of threshold sets each include two thresholds for beam failure detection; and
the control section uses at least one threshold set, among the plurality of threshold sets, per serving cell, for the comparison.

6. A radio base station comprising:
a transmission section that transmits a downlink signal; and
a control section that controls receipt of a comparison result between at least one threshold set among a plurality of threshold sets, with a value that is based on receipt of the downlink signal, wherein:
the plurality of threshold sets are associated with a plurality of communication requirements, respectively; and
the plurality of threshold sets each include a plurality of thresholds for at least one of radio link monitoring and beam failure detection.

7. The user terminal according to claim 2, wherein:
the plurality of threshold sets each include two thresholds for beam failure detection; and
the control section uses at least one threshold set, among the plurality of threshold sets, per serving cell, for the comparison.

8. The user terminal according to claim 3, wherein:
the plurality of threshold sets each include two thresholds for beam failure detection; and
the control section uses at least one threshold set, among the plurality of threshold sets, per serving cell, for the comparison.

9. The user terminal according to claim 4, wherein:
the plurality of threshold sets each include two thresholds for beam failure detection; and
the control section uses at least one threshold set, among the plurality of threshold sets, per serving cell, for the comparison.
